(19) United States
(12) Patent Application Publication
(10) Pub. No.: US 2026/0054308 A1
(43) Pub. Date: Feb. 26, 2026

(54) HEATING DEVICE AND MANUFACTURING METHOD OF CAN BODY

(71) Applicant: Toyo Seikan Co., Ltd., Tokyo (JP)

(72) Inventors: Hiroki TANAKA, Kanagawa (JP); Hideki ISHIGURO, Kanagawa (JP)

(21) Appl. No.: 19/378,146

(22) Filed: Nov. 3, 2025

Related U.S. Application Data
(63) Continuation of application No. PCT/JP2024/017285, filed on May 9, 2024.

(30) Foreign Application Priority Data
Jun. 28, 2023 (JP) 2023-106039

(51) Int. Cl. B21D 51/26; B21D 37/16; C23C 26/00

(52) U.S. Cl. CPC B21D 51/2669; B21D 37/16; C23C 26/00

(57) ABSTRACT

There is provided a heating device heating a can body with hot air, the heating device including a heating unit configured to generate the hot air, a first heating portion configured to heat the can body to raise a temperature of the can body with the hot air, and a second heating portion configured to heat the can body that has been heated to the raised temperature. At least one of the first heating portion or the second heating portion may include a plurality of heating sections having different heating conditions of the can body.

The contents of the following patent application(s) are incorporated herein by reference:
NO. 2023-106039 filed in JP on Jun. 28, 2023, and
NO. PCT/JP2024/017285 filed in WO on May 9, 2024.

### BACKGROUND

### 1. Technical Field

The disclosure relates to a heating device and a manufacturing method of a can body.

### 2. Related Art

JP 07-032487 UM-A discloses “a DI can dryer oven using a clean heating source”.

### BRIEF DESCRIPTION OF THE DRAWINGS

FIG. 1 illustrates an outline of a configuration of a manufacturing system 200.

FIG. 2 illustrates an outline of a configuration of a heating device 100.

FIG. 3 illustrates an example of the configuration of the heating device 100.

FIG. 4A illustrates an example of a cross section of the heating device 100.

FIG. 4B illustrates an example of the cross section of the heating device 100.

FIG. 4C illustrates an example of the cross section of the heating device 100.

FIG. 5 illustrates specific examples of an upper plate 91 and a lower plate 92.

### DESCRIPTION OF EXEMPLARY EMBODIMENTS

Hereinafter, although the disclosure will be described based on an embodiment of the disclosure, the following embodiment does not limit the disclosure according to the claims. Furthermore, all combinations of features described in the embodiment are not necessarily indispensable for the solution of the invention.

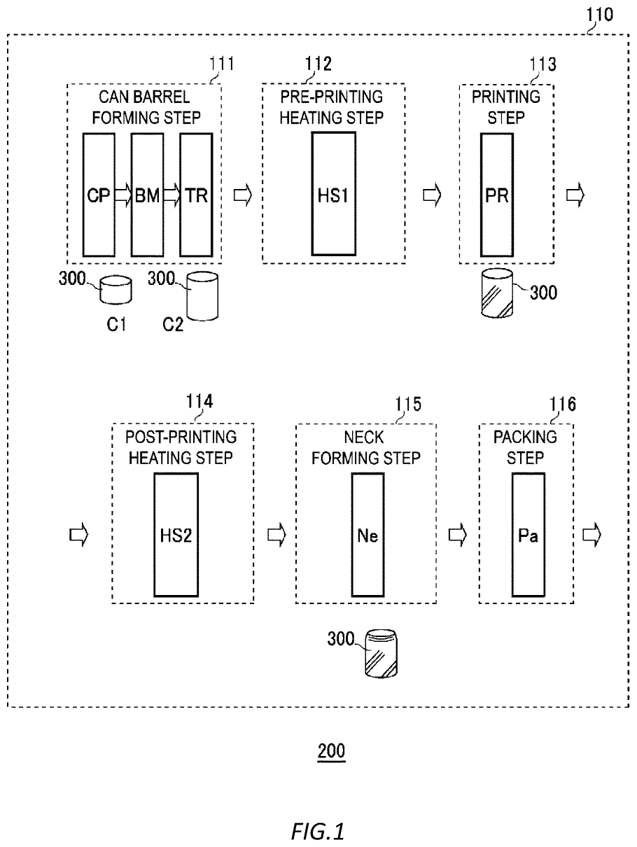

FIG. 1 illustrates an outline of a configuration of a manufacturing system 200. The manufacturing system 200 includes a can body manufacturing line 110 for manufacturing a can body 300. The can body manufacturing line 110 includes a can barrel forming step 111, a pre-printing heating step 112, a printing step 113, a post-printing heating step 114, a neck forming step 115, and a packing step 116. Although the can body 300 of the present example is a cylindrical metal can, the shape and material of the can body 300 are not particularly limited.

In the can barrel forming step 111, a can barrel structure of the can body 300 is formed from a plate-shaped preliminary material. The can barrel forming step 111 may include a step of forming the can body 300 from a resin-coated metal plate. The can barrel forming step 111 of the present example includes a cupping press step (CP), a bodymaker step (BM), and a trimmer step (TR).

In the cupping press step (CP), a circular material member is punched out from a sheet-like metal plate unwound from a coil as a preliminary material, and is formed into a cup shape. The preliminary material may be laminated with a resin film. In the bodymaker step (BM), a cup-shaped material member C1 is drawn and ironed, a can barrel portion is thinned and elongated, and further a can bottom portion is formed, so that a can body C2 is formed. In the trimmer step (TR), an unnecessary portion at an upper end of the can barrel of the can body C2 may be cut off.

The pre-printing heating step 112 includes a first heat setting step (HS1) for heating the can body 300. In the pre-printing heating step 112, the can body 300 may be heated using a heating device 100 described below.

The printing step 113 includes a printing step (PR) of printing a predetermined image on the can body 300. The image may be symbols, signs, characters, numbers, figures, colors, combinations thereof, or a design made by a combination thereof. The content printed in the printing step (PR) is not particularly limited. In the printing step (PR), coating and printing may be performed on the can barrel portion of the can body C2.

The post-printing heating step 114 includes a second heat setting step (HS2) for heating the can body 300. The second heat setting step (HS2) may be a step of baking printed ink on the can body 300. In the post-printing heating step 114, the can body 300 may be heated using the heating device 100 described below. The heating method in the post-printing heating step 114 may be the same as or different from the heating method in the pre-printing heating step 112. The heating condition in the post-printing heating step 114 may be the same as or different from the heating condition in the pre-printing heating step 112.

The neck forming step 115 includes a necking step (Ne). In the necking step (Ne), a die is pressed against an upper portion of the can body 300, and the diameter of the upper portion of the can body 300 is reduced.

In the packing step 116, the manufactured can body 300 is packed. The packing step 116 may include a palletizing step (Pa) of loading the can body 300 on a pallet.

The manufacturing system 200 may include a filling step of filling the can body 300 with a predetermined filling material. The filling step may include a step of attaching a lid to the can body 300 filled with the filling material.

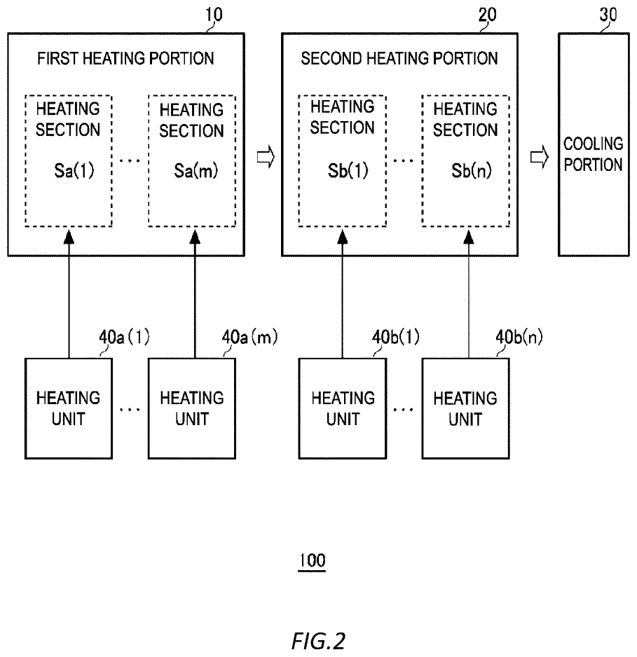

FIG. 2 illustrates an outline of a configuration of the heating device 100. The heating device 100 includes a first heating portion 10, a second heating portion 20, a cooling portion 30, and a heating unit 40.

The heating device 100 heats the can body 300 with hot air. The heating device 100 of the present example conveys the can body 300 to the first heating portion 10 and the second heating portion 20 in this order and heats the can body 300. The heating device 100 may heat the can body 300 in the first heating portion 10 and the second heating portion 20, and then cool the can body 300 in the cooling portion 30.

The first heating portion 10 heats the can body 300 to raise the temperature thereof with hot air. The first heating portion 10 may heat the can body 300 conveyed from the can barrel forming step 111, or may heat the can body 300 conveyed from the pre-printing heating step 112. The first heating portion 10 may heat the can body 300 to raise the temperature of the can body 300 from the room temperature to a predetermined temperature.

The second heating portion 20 heats the can body 300 that has been heated to the raised temperature by the first heating portion 10. The second heating portion 20 may heat the can body 300 that has been heated to the raised temperature and maintain the predetermined temperature. The second heating portion 20 may maintain the temperature of the can body 300 so that the temperature of the can body 300 falls within a predetermined temperature range. The second heating portion 20 may maintain the temperature of the can body 300 so as not to fall below the predetermined temperature. For example, the second heating portion 20 maintains the temperature of the can body 300 so as not to fall below the temperature of the can body 300 at the time of conveyance to the second heating portion 20. In this way, maintaining the predetermined temperature may include not only a case where the temperature of the can body 300 is constant but also a case where the temperature of the can body 300 increases or decreases.

At least one of the first heating portion 10 or the second heating portion 20 may include a plurality of heating sections S having different heating conditions of the can body 300. The first heating portion 10 and the second heating portion 20 of the present example each have the plurality of heating sections S. In the present specification, the term “heating section S” may refer to any one or more heating sections included in the heating device 100.

The heating condition may be at least one of the temperature, the amount of air, or the heating time in the heating section S. The heating condition may include the intake amount of air taken in from outside a circulation path 60 described below, and may include the exhaust amount of air discharged from the circulation path 60. The heating condition may include the presence or absence of a device to be disposed, such as the presence or absence of a removal device 70 described below.

The first heating portion 10 may include one or more heating sections Sa having different heating conditions of the can body 300. In the present specification, the term “heating section Sa” may refer to any one or more heating sections included in the first heating portion 10. The first heating portion 10 of the present example includes m heating sections Sa, that is, a heating section Sa(1) to a heating section Sa(m). The variable m is an integer of 1 or more. The first heating portion 10 may include the plurality of heating sections Sa, and may change the temperature setting of the heating unit 40 for each heating section Sa according to the temperature of the can body 300.

The first heating portion 10 of the present example can shorten a temperature rise time by setting the temperature of the heating section Sa to be equal to or more than the final temperature reached in the first heating portion 10. In addition, by shortening the temperature rise time, the length of the first heating portion 10 can be shortened. The first heating portion 10 can suppress the overshoot of the can temperature by setting the temperature of the heating section Sa in the latter half of the plurality of heating sections Sa to be lower than the temperature of the heating section Sa in the first half.

The second heating portion 20 may include one or more heating sections Sb having different heating conditions of the can body 300. In the present specification, the term “heating section Sb” may refer to any one or more heating sections included in the second heating portion 20. The second heating portion 20 of the present example includes n heating sections Sb, that is, a heating section Sb(1) to a heating section Sb(n). The variable n is an integer of 1 or more. The number n of the heating sections Sb of the second heating portion 20 may be the same as or different from the number m of the heating sections Sa of the first heating portion 10. The number n of the heating sections Sb of the second heating portion 20 may be smaller or larger than the number m of the heating sections Sa of the first heating portion 10.

The cooling portion 30 is provided in a stage subsequent to the second heating portion 20 and cools the can body 300. The cooling portion 30 may air-cool the can body 300, or may cool the can body 300 by a method other than air cooling. The cooling portion 30 may cool the can body 300 so that the can body 300 reaches a predetermined temperature or less within a predetermined time. For example, the can body 300 is cooled so that the can body 300 reaches 80° C. or less within 20 seconds. Slow cooling of a resin-coated can may cause the resin to become brittle. However, a decrease in the strength of the can body 300 can be suppressed by the cooling portion 30 cooling the can body 300. The cooling condition may be changed according to the material of the resin covering the can body 300.

The heating unit 40 generates hot air for heating the can body 300. The heating unit 40 may be an electric heater for generating hot air. By using an electric heater as the heating unit 40, the heating device 100 can be easily divided into the plurality of heating sections S as compared with a gas-type combustion device. When an electric heater is used as the heating unit 40, water is not generated by combustion unlike a combustion device, and thus the can body 300 is easily dried.

The heating device 100 may include a plurality of heating units 40. At least one heating unit 40 of the plurality of heating units 40 may be provided for each of the plurality of heating sections S. Further, one heating unit 40 may be provided for a plurality of heating sections S having the same temperature. The heating device 100 of the present example includes a heating unit 40a(1) to a heating unit 40a(m) for blowing hot air to the first heating portion 10, and a heating unit 40b(1) to a heating unit 40b(n) for blowing hot air to the second heating portion 20. In the present specification, the term “heating unit 40a” may refer to one or more heating units 40 for blowing hot air to the first heating portion 10. In the present specification, the term “heating unit 40b” may refer to one or more heating units 40 for blowing hot air to the second heating portion 20.

The heating unit 40a(1) to the heating unit 40a(m) are provided to correspond to the heating section Sa(1) to the heating section Sa(m) of the first heating portion 10, respectively. The amounts of hot air generated by the heating unit 40a(1) to the heating unit 40a(m) may be the same or different from each other.

The heating unit 40b(1) to the heating unit 40b(n) are provided to correspond to the heating section Sb(1) to the heating section Sb(n) of the second heating portion 20, respectively. The amounts of hot air generated by the heating unit 40b(1) to the heating unit 40b(n) may be the same or different from each other.

The heating device 100 may change each of the heating conditions of the heating sections S. The heating device 100 may change each of the heating conditions of the heating sections Sa of the first heating portion 10, and may change each of the heating conditions of the heating sections Sb of the second heating portion 20. By adjusting each of the heating conditions of the heating sections S according to the temperature of the can body 300, the energy efficiency can be improved.

For example, the amount of air supplied from the heating unit 40a in the first heating portion 10 is set to be larger than the amount of air supplied from the heating unit 40b in the second heating portion 20. By increasing the amount of air supplied from the heating unit 40a in the first heating portion 10, the temperature rise time of the can body 300 can be shortened. When the number of can bodies 300 present in each heating section S is different due to a difference in the length of the heating section S, the amount of air supplied from the heating unit 40 may be compared using the amount of air per can, that is, a value obtained by dividing the amount of air supplied to the heating section S by the number of can bodies 300 present in the heating section S.

In the present example, the amount of air supplied from the heating unit 40 is compared, but the speed of air blown to the can body 300 may be compared, or the circulation amount per can circulating through the circulation path 60 described below may be compared. The maximum air amount in the plurality of heating sections Sa of the first heating portion 10 may be larger than the minimum air amount in the plurality of heating sections Sb of the second heating portion 20. In addition, the minimum air amount in the plurality of heating sections Sa of the first heating portion 10 may be larger than the maximum air amount in the plurality of heating sections Sb of the second heating portion 20.

The heating device 100 of the present example can set the temperature for each heating section S by providing the heating unit 40 for each heating section S. The heating device 100 may set the temperature of at least one heating section Sa of the first heating portion 10 to be higher than the temperature of the heating section Sb of the second heating portion 20. In addition, in the heating device 100, the first heating portion 10 is divided into the plurality of heating sections Sa, and thus the amount of air of the first heating portion 10 can be set to be larger than the amount of air for maintaining the temperature in the second heating portion 20. This can shorten the temperature rise time of the can body 300.

The heating device 100 may include a temperature sensor for measuring the temperature of the can body 300 for each heating section S. A thermocouple may be attached to the can body 300 to measure a change in the temperature of the can body 300. The heating device 100 may adjust the heating condition of the can body 300 for each heating section S according to the measured temperature.

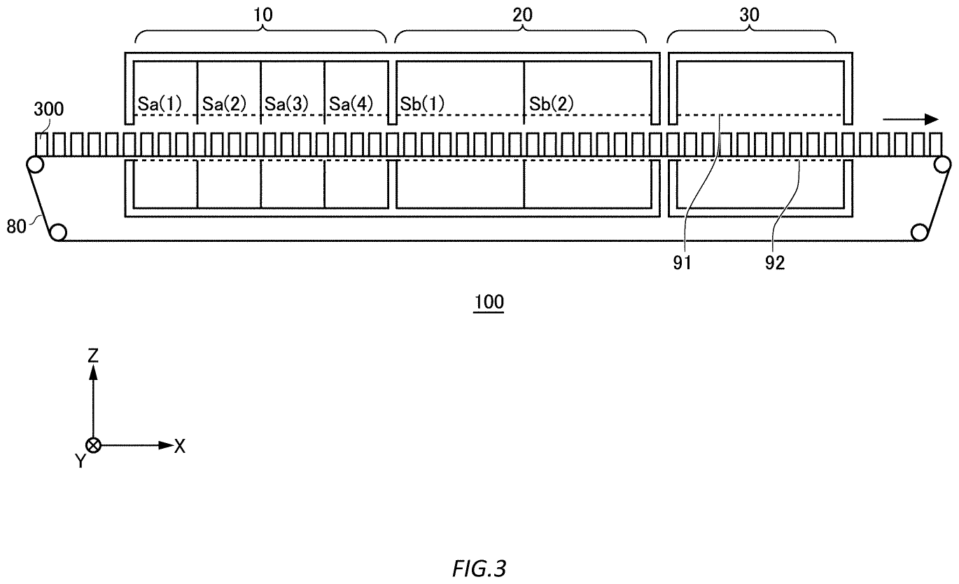

FIG. 3 illustrates an example of the configuration of the heating device 100. In the present example, the first heating portion 10, the second heating portion 20, and the cooling portion 30 are arranged side by side in the X-axis direction, and the can bodies 300 are conveyed in the X-axis direction. The can bodies 300 of the present example are arranged at given intervals in the X-axis direction. The plurality of can bodies 300 may be arranged in the Y-axis direction.

The first heating portion 10 of the present example includes four heating sections Sa, that is, a heating section Sa(1) to a heating section Sa(4). That is, the number m of the heating sections Sa in the first heating portion 10 is four. The heating times of the heating section Sa(1) to the heating section Sa(4) may be the same. That is, the lengths of the heating section Sa(1) to the heating section Sa(4) in the traveling direction of the can bodies 300 may be the same. However, the heating times of the heating section Sa(1) to the heating section Sa(4) may be different.

The second heating portion 20 of the present example includes two heating sections Sb, that is, a heating section Sb(1) and a heating section Sb(2). That is, the number n of the heating sections Sb in the second heating portion 20 is two. The heating times of the heating section Sb(1) and the heating section Sb(2) may be the same or different. The number of the heating sections S of each of the first heating portion 10 and the second heating portion 20 is not limited to the present example.

Each can body 300 may be a resin-coated can coated with resin. The first heating portion 10 and the second heating portion 20 may heat the resin-coated can obtained by coating the can body 300 with resin. Here, strain may occur in the resin film coated on the can body 300. The strain occurring in the resin film may be removed by being heated by the heating device 100. When the heating device 100 is used in the post-printing heating step 114, the can body 300 may be a printed can on which a predetermined image is printed.

A conveyor 80 conveys the can body 300 in the order of the first heating portion 10, the second heating portion 20, and the cooling portion 30. The can body 300 may be placed on the conveyor 80. The interval between the can bodies 300 in the X-axis direction may be adjusted by using a speed difference between a supply speed at which the can bodies 300 are supplied to the heating device 100 and a conveyance speed of the conveyor 80 of the heating device 100. The interval between the can bodies 300 in the Y-axis direction may be controlled using a given sorting device so that the can bodies 300 do not come into contact with each other.

An upper plate 91 is provided above the can bodies 300. The upper plate 91 may be provided in each of the first heating portion 10, the second heating portion 20, and the cooling portion 30. The upper plate 91 will be described below.

A lower plate 92 is provided below the can bodies 300. The lower plate 92 may be provided below the conveyor 80 on which the can bodies 300 are placed. The lower plate 92 may be provided in each of the first heating portion 10, the second heating portion 20, and the cooling portion 30. The lower plate 92 will be described below.

Here, the first heating portion 10, the second heating portion 20, and the cooling portion 30 may be capable of being separately assembled. At least one heating section Sa of the plurality of heating sections Sa of the first heating portion 10 and/or at least one heating section Sb of the heating sections Sb of the second heating portion 20 may be capable of being assembled separately from the other heating sections S. That is, at least one of the plurality of heating sections Sa may be capable of being assembled separately from the other heating sections Sa. Similarly, at least one of the plurality of heating sections Sb may be capable of being assembled separately from the other heating sections Sb.

By allowing the heating device 100 to be separately assembled, the transport efficiency is improved and the device can be easily installed. By providing the plurality of heating units 40, the size per unit is reduced and the transport efficiency is improved.

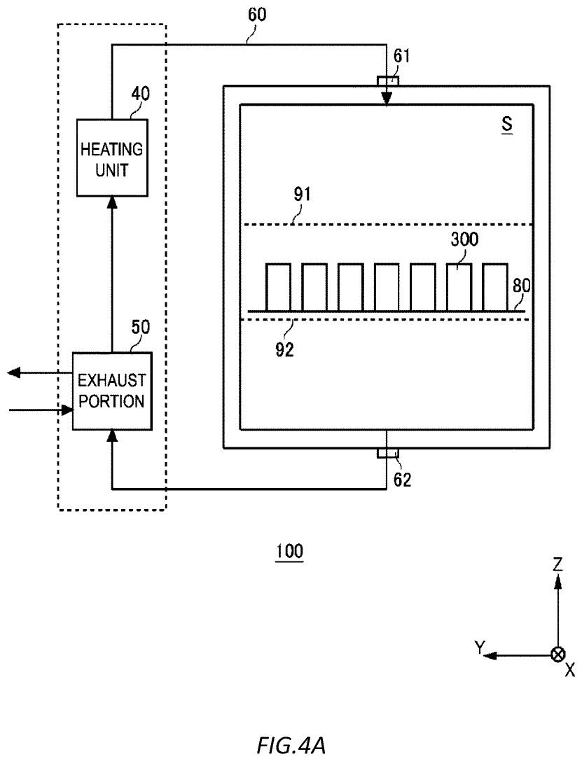

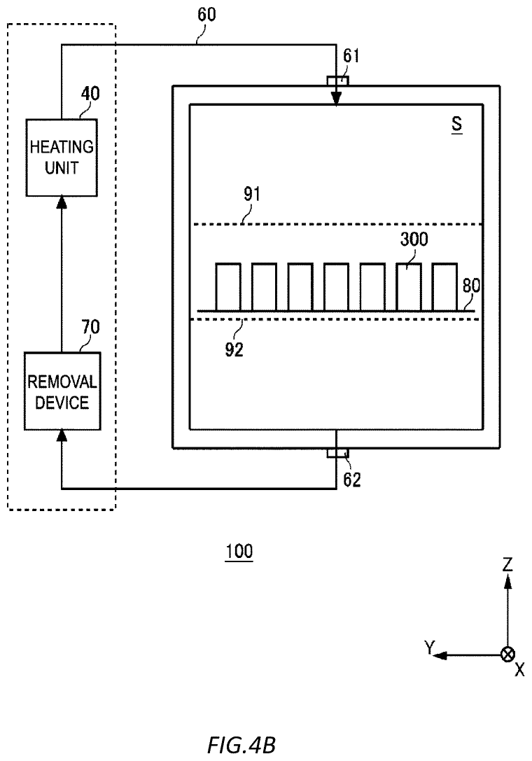

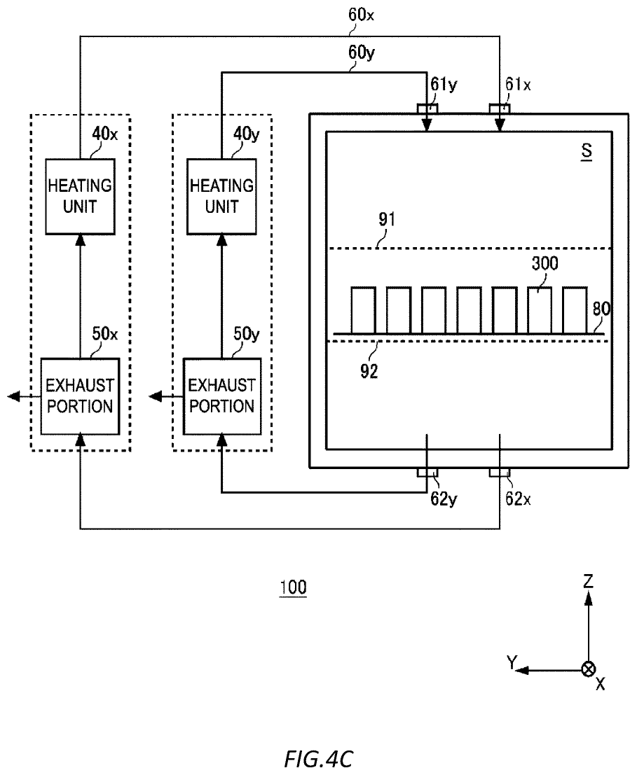

FIG. 4A illustrates an example of a cross section of the heating device 100. The heating device 100 of the present example includes the heating unit 40 and an exhaust portion 50 in the circulation path 60 in a given heating section S. This figure illustrates the YZ cross section of the heating device 100. The plurality of can bodies 300 may be arranged at given intervals in the Y-axis direction. The interval between the can bodies 300 may be controlled using a given sorting device so that the can bodies 300 do not come into contact with each other.

The circulation path 60 is provided in the heating section S and circulates hot air generated by the heating unit 40. The circulation path 60 recovers the hot air that has heated the can bodies 300, reheats the hot air using the heating unit 40, and circulates the hot air. The circulation path 60 of the present example blows the hot air generated by the heating unit 40 to the can bodies 300 via a supply port 61, and recovers the hot air that has heated the can bodies 300 via a discharge port 62. The circulation path 60 may be provided in each of the plurality of heating sections S. By providing the circulation path 60, it is possible to reuse the hot air that has heated the can bodies 300 without providing a heat exchanger.

The heating unit 40 is provided in the circulation path 60 and blows the hot air from above the can bodies 300. The heating unit 40 may be provided on the lateral side of the heating section S. That is, the heating unit 40a may be provided on the lateral side of the first heating portion 10, and the heating unit 40b may be provided on the lateral side of the second heating portion 20.

Each can body 300 of the present example is placed on the conveyor 80 in an inverted state with the bottom portion of the can body 300 facing upward. In a state where the bottom portion having a higher weight ratio faces upward in this manner, the hot air from the heating unit 40 is blown from above, so that the can body 300 can be efficiently heated. Further, by conveying the can body 300 in the inverted state, the upper portion of the can body 300 having a larger diameter than the bottom portion comes into contact with the conveyor 80. This increases the ground contact diameter with the conveyor 80, and the can body 300 is less likely to fall over.

The exhaust portion 50 is provided to correspond to the heating section S and exhausts the hot air. The heating device 100 may include a plurality of exhaust portions 50 provided to correspond to the plurality of heating sections S. For each of the plurality of heating sections S in which the plurality of exhaust portions 50 are provided, a corresponding one of the plurality of exhaust portions 50 may adjust an exhaust amount. The exhaust portion 50 may take in air from the outside and supply the air to the circulation path 60. The heating unit 40 may take in the air supplied from the outside, in addition to the air circulating through the circulation path 60.

The exhaust portion 50 may be provided at a given position of the circulation path 60. The exhaust portion 50 of the present example is provided between the heating unit 40 and the can bodies 300 in the circulation path 60. The exhaust portion 50 of the present example is provided on the lateral side of the heating section S, but the present disclosure is not limited thereto.

Here, the can bodies 300 may contain a volatile component such as wax volatilized by heating. When the component volatilized by the heating circulates in the circulation path 60, the concentration of the volatile component may increase. The heating device 100 of the present example includes the exhaust portion 50, and thus can adjust the concentration of the volatile component.

The exhaust portion 50 may determine the exhaust amount according to the volatilization amount of the volatile component generated by heating the can bodies 300. The exhaust portion 50 may set the exhaust amount in the heating section S in which the volatilization amount from the can bodies 300 is larger to be larger than the exhaust amount in the heating section S in which the volatilization amount from the can bodies 300 is smaller. The exhaust amount in the last heating section Sa(m) of the plurality of heating sections Sa of the first heating portion 10 may be larger than the exhaust amount in the first heating section Sa(1) of the plurality of heating sections Sa of the first heating portion 10. The exhaust amount in the first heating section Sb(1) of the plurality of heating sections Sb of the second heating portion 20 may be larger than the exhaust amount in the last heating section Sb(n) of the plurality of heating sections Sb of the second heating portion 20.

The heating device 100 of the present example can improve energy efficiency by circulating the hot air that has heated the can bodies 300 using the circulation path 60. The heating device 100 may select whether or not to provide the exhaust portion 50 according to the concentration of the volatile component in each heating section S, and may adjust the exhaust amount of the exhaust portion 50 according to the concentration of the volatile component in each heating section S. In the heating device 100, the exhaust portion 50 may be omitted or the exhaust amount may be reduced in the heating section S in which the temperature of the can bodies 300 is relatively low, such as the first heating section Sa(1) of the first heating portion 10. The heating device 100 can improve energy efficiency by adjusting the exhaust amount in each heating section S.

FIG. 4B illustrates an example of the cross section of the heating device 100. The heating device 100 of the present example includes the heating unit 40 and a removal device 70 provided in the circulation path 60 of a given heating section S.

The circulation path 60 of the present example does not exhaust hot air that has heated the can bodies 300, and reheats the hot air using the heating unit 40 and circulates the hot air. The circulation path 60 that does not exhaust the hot air as in the present example may be provided in at least one heating section S of the plurality of heating sections S. The circulation path 60 that does not exhaust the hot air may be provided in the heating section Sa of the first heating portion 10 or may be provided in the heating section Sb of the second heating portion 20.

The removal device 70 removes a volatile component from the can bodies 300. The removal device 70 may be provided in at least one heating section S of the plurality of heating sections S. By providing the removal device 70, it is possible to suppress an increase in the concentration of the volatile component even when the circulation path 60 does not exhaust the hot air. However, the removal device 70 may be provided in the circulation path 60 in which the exhaust portion 50 is provided.

In the heating device 100, the removal device 70 may be provided in each of some of the plurality of heating sections S or may be provided in each of all of the plurality of heating sections S. In the heating device 100 of the present example, the removal device 70 is preferentially disposed in the heating section S in which the volatile component is most desired to be removed, and thus it is possible to effectively remove the volatile component of the can bodies 300 while suppressing the cost of providing the removal device 70. For example, the removal device 70 is provided in the first heating section Sb(1) of the plurality of heating sections Sb of the second heating portion 20. The removal device 70 may be provided in the last heating section Sa(m) of the first heating portion 10.

FIG. 4C illustrates an example of the cross section of the heating device 100. The heating device 100 of the present example includes a plurality of circulation paths 60 in a given heating section S. The heating device 100 of the present example includes two circulation paths 60, that is, a circulation path 60x and a circulation path 60y.

Two or more heating units 40 may be provided in at least one heating section S of the plurality of heating sections S. The heating device 100 of the present example heats the can bodies 300 in the heating section S with hot air from the plurality of heating units 40, that is, a heating unit 40x and a heating unit 40y. The heating device 100 may include the plurality of heating units 40 disposed in the circulation paths 60 provided in parallel, such as the heating unit 40x and the heating unit 40y. By using electric heaters as the heating units 40, it becomes easy to dispose the plurality of heating units 40 in a single heating section S.

The heating unit 40x is provided in the circulation path 60x. The circulation path 60x blows hot air generated by the heating unit 40x to the can bodies 300 through a supply port 61x, and recovers the hot air that has heated the can bodies 300 through a discharge port 62x.

The heating unit 40y is provided in the circulation path 60y. The circulation path 60y blows hot air generated by the heating unit 40y to the can bodies 300 through a supply port 61y, and recovers the hot air that has heated the can bodies 300 through a discharge port 62y.

The heating device 100 of the present example can suppress temperature unevenness in the heating section S by using the plurality of heating units 40 for the single heating section S. In the heating device 100, the plurality of heating units 40 may be provided in each of the plurality of heating sections S, or the plurality of heating units 40 may be provided in each of some of the plurality of heating sections S. In FIG. 4C, two exhaust portions 50x and 50y are provided in the single heating section S, but these exhaust portions may be combined into a single exhaust portion 50, and the single exhaust portion 50 may be branched and connected to the plurality of heating units 40x and 40y.

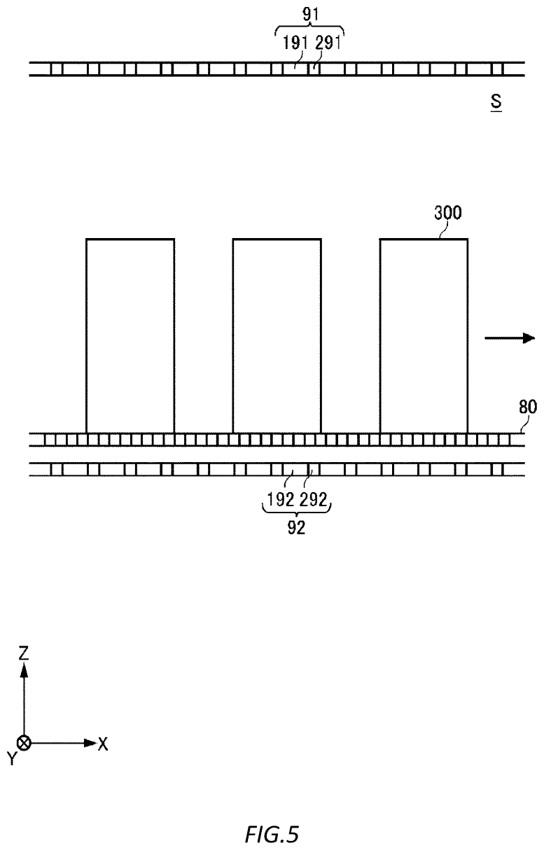

FIG. 5 illustrates specific examples of the upper plate 91 and the lower plate 92. The upper plate 91 may include a plate portion 191 and an opening 291. The lower plate 92 may include a plate portion 192 and an opening 292.

The plate portion 191 and the plate portion 192 may be plates made of metal such as iron. The opening 291 is provided in the plate portion 191 to allow hot air generated by the heating unit 40 to pass therethrough. By providing the opening 291 in the upper plate 91, the hot air can be more uniformly blown to the can bodies 300. The opening 292 is provided in the plate portion 192 to allow the hot air that has heated the can bodies 300 to pass therethrough.

The conveyor 80 may be a mesh conveyor. By using a mesh conveyor as the conveyor 80, it becomes easy to circulate the hot air from the heating unit 40. The conveyor 80 may be a resin net in which holes are formed in a resin, or may be a metal mesh. By forming the conveyor 80 of a material having a small heat capacity, it is possible to reduce energy loss when the conveyor 80 is cooled outside the heating portion and heated again by the heating portion. A step at joints of the resin nets can be reduced by bonding the joints, and the can bodies 300 can be placed also at the joints.

Although the disclosure has been described above using the embodiment, the technical scope of the disclosure is not limited to the scope described in the above embodiment. It is apparent to one skilled in the art that the above embodiment can be variously changed or modified. It is clear from the recitation of the claims that the variously changed or modified embodiment is also included in the technical scope of the disclosure.

It should be noted that the order of execution of each processing such as the operations, the procedures, the steps, and the stages of the device, the system, the programs, and the methods described and illustrated in the claims, the description, and the drawings is not explicitly described using words such as “before” and “prior to”, and may be implemented in any order unless an output of previous processing is used for subsequent processing. Even if the operation flows in the claims, the specification, and the drawings are described using words such as “first” and “next” for convenience of description, this does not mean that it is essential to perform the operations in this order.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A heating device heating a can body with hot air, the heating device comprising:
a heating unit configured to generate the hot air;
a first heating portion configured to heat the can body to raise a temperature of the can body with the hot air; and
a second heating portion configured to heat the can body that has been heated to the raised temperature, wherein
at least one of the first heating portion or the second heating portion includes a plurality of heating sections having different heating conditions of the can body.

2. The heating device according to claim 1, wherein
the second heating portion heats the can body that has been heated to the raised temperature and maintains a predetermined temperature.

3. The heating device according to claim 1, wherein
the heating unit is an electric heater configured to generate the hot air.

4. The heating device according to claim 1, comprising:
a plurality of the heating units configured to generate the hot air, wherein
at least one heating unit of the plurality of heating units is provided in each of the plurality of heating sections.

5. The heating device according to claim 1, wherein
two or more of the heating units are provided in at least one heating section of the plurality of heating sections.

6. The heating device according to claim 1, wherein
a temperature of at least one heating section among one or more heating sections of the first heating portion is higher than a temperature of one or more heating sections of the second heating portion.

7. The heating device according to claim 1, wherein
an amount of air supplied from the heating unit in the first heating portion is larger than an amount of air supplied from the heating unit in the second heating portion.

8. The heating device according to claim 1, comprising:
a plurality of exhaust portions provided to correspond to the plurality of heating sections and configured to exhaust the hot air, wherein
for each of the plurality of heating sections in which the plurality of exhaust portions are provided, a corresponding one of the plurality of exhaust portions adjusts an exhaust amount.

9. The heating device according to claim 8, wherein
the exhaust amount of a last heating section of the plurality of heating sections of the first heating portion is larger than the exhaust amount of a first heating section of the plurality of heating sections of the first heating portion.

10. The heating device according to claim 8, wherein
the exhaust amount of a first heating section of the plurality of heating sections of the second heating portion is larger than the exhaust amount of a last heating section of the plurality of heating sections of the second heating portion.

11. The heating device according to claim 1, wherein
each of the plurality of heating sections includes a circulation path configured to recover the hot air that has heated the can body, reheat the hot air using the heating unit, and circulate the hot air.

12. The heating device according to claim 1, wherein
at least one heating section of the plurality of heating sections includes a circulation path configured to reheat the hot air using the heating unit and circulate the hot air without exhausting the hot air that has heated the can body.

13. The heating device according to claim 1, wherein
at least one heating section of the plurality of heating sections includes a removal device configured to remove a volatile component from the can body.

14. The heating device according to claim 13, wherein
the removal device is provided in a first heating section of the plurality of heating sections of the second heating portion.

15. The heating device according to claim 1, comprising:
a cooling portion provided in a subsequent stage of the second heating portion and configured to cool the can body.

16. The heating device according to claim 1, wherein
at least one heating section of the plurality of heating sections of the first heating portion and/or at least one heating section of the plurality of heating sections of the second heating portion is capable of being assembled separately from other heating sections.

17. A method of manufacturing a can body, the method comprising:
generating hot air heating the can body;
heating, by a first heating portion, the can body to raise a temperature of the can body with the hot air; and
heating, by a second heating portion, the can body that has been heated to the raised temperature, wherein
at least one of the first heating portion or the second heating portion includes a plurality of heating sections having different heating conditions of the can body.

18. The method of manufacturing the can body according to claim 17, the method comprising:
forming the can body from a metal plate coated with resin, wherein
the first heating portion and the second heating portion heat a resin-coated can obtained by coating the can body with resin.

19. The heating device according to claim 4, wherein
at least one heating section of the plurality of heating sections includes a removal device configured to remove a volatile component from the can body.

20. The heating device according to claim 4, comprising:
a cooling portion provided in a subsequent stage of the second heating portion and configured to cool the can body.
